(19) United States
(12) Patent Application Publication
(10) Pub. No.: US 2024/0210292 A1
(43) Pub. Date: Jun. 27, 2024

(54) MATERIAL TESTING MACHINE AND FIXING MECHANISM

(71) Applicant: SHIMADZU CORPORATION, Kyoto (JP)

(72) Inventor: Maiko KARITA, Kyoto (JP)

(73) Assignee: SHIMADZU CORPORATION, Kyoto (JP)

(21) Appl. No.: 18/390,580

(22) Filed: Dec. 20, 2023

(30) Foreign Application Priority Data
Dec. 27, 2022 (JP) 2022-209655

(51) Int. Cl. G01N 3/02; G01N 3/08

(52) U.S. Cl. CPC G01N 3/02; G01N 3/08; G06F 3/167

(57) ABSTRACT

A tensile testing machine includes a voice operation device, in which the voice operation device is attached to a machine column via a fixing mechanism, and the fixing mechanism includes: three or more elastic bodies attached to either one side of the machine column and the voice operation device and disposed in contact with another side; and a magnet body attached to the other side and disposed in non-contact with the one side to suck and fix the one side.

### INCORPORATION BY REFERENCE

The present application claims priority under 35 U.S.C. § 119 to Japanese Patent Application No. 2022-209655 filed on Dec. 27, 2022. The content of the application is incorporated herein by reference in its entirety.

### BACKGROUND

### Technical Field

The present invention relates to a material testing machine and a fixing mechanism.

### Related Art

Various techniques for operating a material testing machine by voice recognition processing have been known.

For example, JP 2022-175407 A describes a tensile testing machine having the following configuration. That is, the tensile testing machine includes a testing machine main body that performs a material test, a correspondence storage unit that stores a specific word and instruction information for the testing machine main body in association with each other, a voice receiving unit that receives a voice from a user, an extraction unit that extracts the specific word from the voice by voice recognition processing, a determination unit that refers to the correspondence storage unit and determines instruction information corresponding to the specific word extracted by the extraction unit, and an instruction unit that outputs the instruction information determined by the determination unit to the testing machine main body.

### SUMMARY

In the tensile testing machine described in JP 2022-175407 A and the like, it is necessary to fix, to a machine column or the like of a testing machine main body, a microphone that acquires, as a voice signal, a voice uttered by an operator. However, when, for example, a crosshead is moved up and down, vibration may be transmitted from the crosshead to the machine column, and noise may be generated in the microphone fixed to the machine column. In this case, there is a possibility that a word cannot be extracted from the voice by voice recognition processing.

The present invention has been made in view of such circumstances, and an object thereof is to provide a material testing machine and a fixing mechanism capable of suppressing vibration transmitted from a testing machine main body to a microphone.

A first aspect of the present invention relates to a material testing machine including a voice operation device, in which the voice operation device is attached to a machine column via a fixing mechanism, and the fixing mechanism includes: three or more elastic bodies attached to either one side of the machine column and the voice operation device and disposed in contact with another side; and a magnet body attached to the other side and disposed in non-contact with the one side to suck and fix the one side.

A second aspect of the present invention relates to a fixing mechanism for fixing a voice operation device to a machine column of a material testing machine, the fixing mechanism including: three or more elastic bodies attached to either one side of the machine column and the voice operation device and disposed in contact with another side; and a magnet body attached to the other side and disposed in non-contact with the one side to suck and fix the one side.

According to the first aspect of the present invention and the second aspect of the present invention, for example, “one side” is a side of the voice operation device, and “the other side” is a side of the machine column. In this case, the three or more elastic bodies are attached to the side of the voice operation device and are disposed in contact with the side of the machine column. In addition, the magnet body is attached to the side of the machine column, and is disposed in non-contact with the voice operation device to suck and fix the side of the voice operation device.

Therefore, vibration from the machine column to the voice operation device is transmitted only through three or more elastic bodies. In addition, since the three or more elastic bodies have elasticity and are disposed in contact with the side of the machine column, transmission of vibration from the machine column to the voice operation device is suppressed.

Furthermore, for example, “one side” is a side of the machine column, and “the other side” is a side of the voice operation device. In this case, the three or more elastic bodies are attached to the side of the machine column and are disposed in contact with the side of the voice operation device. In addition, the magnet body is attached to the side of the voice operation device, and is disposed in non-contact with the machine column to suck and fix the side of the voice operation device.

Therefore, vibration from the machine column to the voice operation device is transmitted only through three or more elastic bodies. In addition, since the three or more elastic bodies have elasticity and are disposed in contact with the side of the voice operation device, transmission of vibration from the machine column to the voice operation device is suppressed.

### BRIEF DESCRIPTION OF DRAWINGS

FIG. 1 is a diagram illustrating an example of a configuration of a tensile testing machine according to an embodiment of the present invention;

FIG. 2 is a side view illustrating an example of a configuration of a tensile testing machine main body;

FIG. 3 is a plan view illustrating an example of the configuration of the tensile testing machine main body;

FIG. 4 is a plan view illustrating an example of a configuration of a fixing mechanism of a voice operation device;

FIG. 5 is a side view illustrating an example of the configuration of the fixing mechanism of the voice operation device; and

FIG. 6 is a rear view of a stand illustrating an arrangement of elastic bodies.

### DETAILED DESCRIPTION

Hereinafter, embodiments of the present invention will be described with reference to the drawings.

### 1. Configuration of Tensile Testing Machine

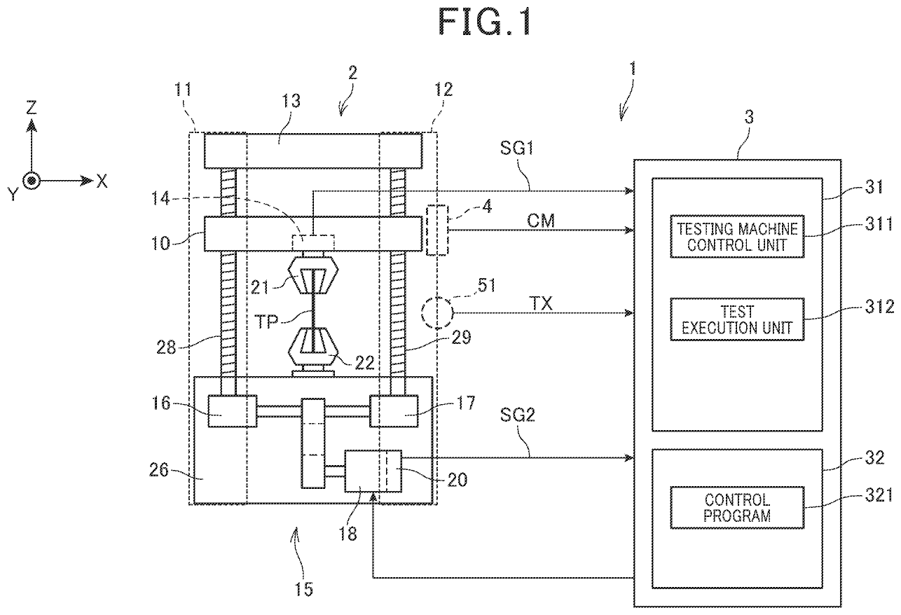

FIG. 1 is a diagram illustrating an example of a configuration of a tensile testing machine 1 according to an embodiment of the present invention.

The tensile testing machine 1 according to the embodiment of the present invention performs a material test for measuring mechanical properties such as tensile strength and yield point of a sample by applying a test force F to a test piece TP. The test force F is a tensile force.

The tensile testing machine 1 includes a tensile testing machine main body 2 that performs a tension test by applying the test force F to the test piece TP that is a material to be tested, and a control device 3 that controls a tensile test operation by the tensile testing machine main body 2.

The tensile testing machine 1 corresponds to an example of a “material testing machine”.

In each of FIGS. 1 to 5, an X axis, a Y axis, and a Z axis orthogonal to each other are described in order to describe structures of the tensile testing machine main body 2 and a fixing mechanism 5. The Z axis is parallel to the vertical direction, and the X axis and the Y axis are parallel to the horizontal direction. The X-axis is parallel to a left-right direction of the tensile testing machine main body 2, and the Y-axis is parallel to a front-rear direction of the tensile testing machine main body 2. A positive direction of the X axis indicates a right direction, a positive direction of the Y axis indicates a front direction, and a positive direction of the Z axis indicates an upper direction.

### [1-1. Configuration of Tensile Testing Machine Main Body]

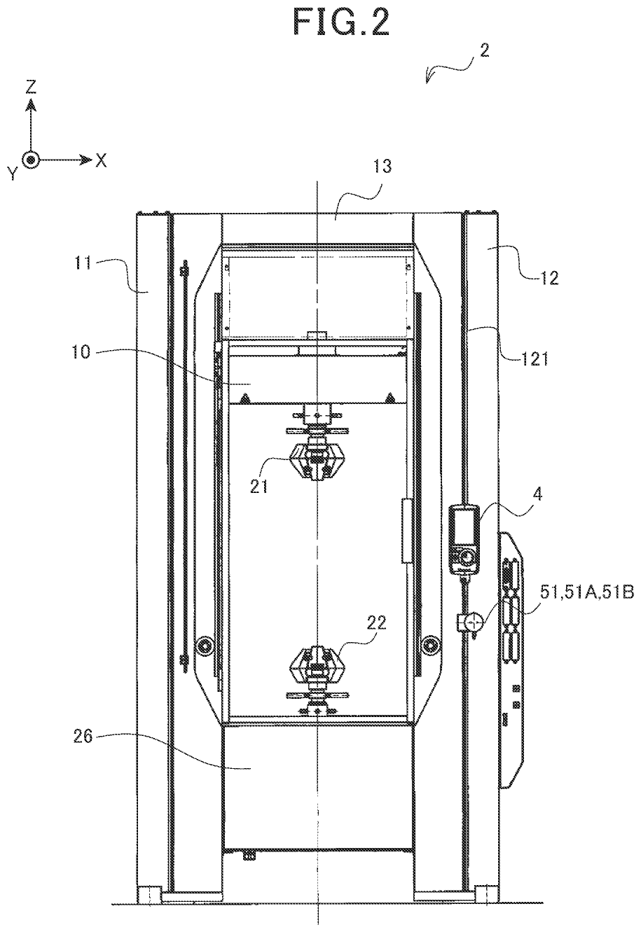

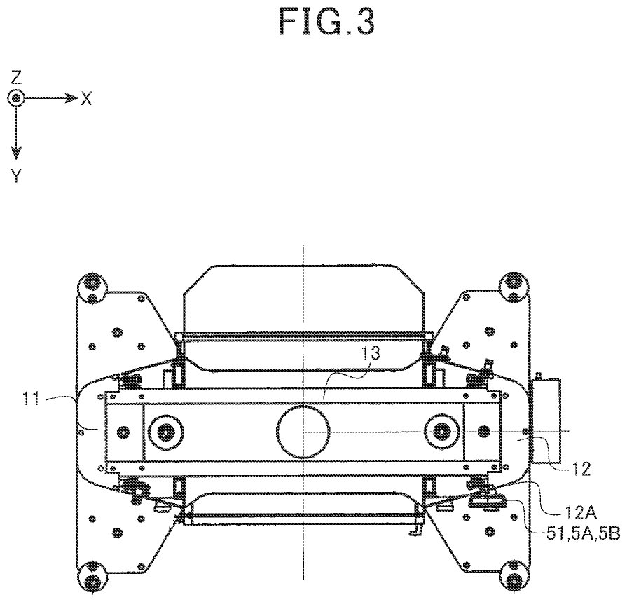

First, the structure of the tensile testing machine main body 2 according to the present invention and an arrangement of a voice operation device 51 will be described with reference to FIGS. 2 and 3.

FIG. 2 is a side view illustrating an example of a configuration of the tensile testing machine main body 2. FIG. 3 is a plan view illustrating an example of the configuration of the tensile testing machine main body 2.

As illustrated in FIG. 2, the tensile testing machine main body 2 has a gate-shaped structure in a side view, including a machine column 11, a machine column 12, and a top plate 13. Each of the machine column 11 and the machine column 12 is erected on a foundation such as a floor surface. Each of the machine column 11 and the machine column 12 extends in the Z-axis direction, that is, an upper-lower direction. One end of the top plate 13 is fixed to an upper end of the machine column 11, and the other end of the top plate 13 is fixed to an upper end of the machine column 12.

In addition, a table 26 and a crosshead 10 are disposed between the machine column 11 and the machine column 12. A lower gripper 22 is fixed to an upper surface of the table 26, and an upper gripper 21 is fixed to a lower surface of the crosshead 10. As illustrated in FIG. 1, the upper gripper 21 grips an upper end of the test piece TP. As illustrated in FIG. 1, the lower gripper 22 grips a lower end of the test piece TP. When the crosshead 10 is raised with the test piece TP gripped by the upper gripper 21 and the lower gripper 22, the test force F which is a tensile load is applied to the test piece TP.

In addition, a groove 121 extending in the upper-lower direction is formed in the machine column 12. An operation unit 4 and the voice operation device 51 are fixed to the machine column 12 via the groove 121.

The operation unit 4 receives an operator's operation, generates a signal corresponding to the received operation, and transmits the generated signal to the control device 3.

The voice operation device 51 includes a microphone 51A and a voice recognition board 51B. The microphone 51A generates a voice signal corresponding to a voice of an operator, and outputs the generated voice signal to the voice recognition board 51B. The voice recognition board 51B performs voice recognition processing on the voice signal, generates text information TX corresponding to the voice signal, and transmits the generated text information TX to the control device 3.

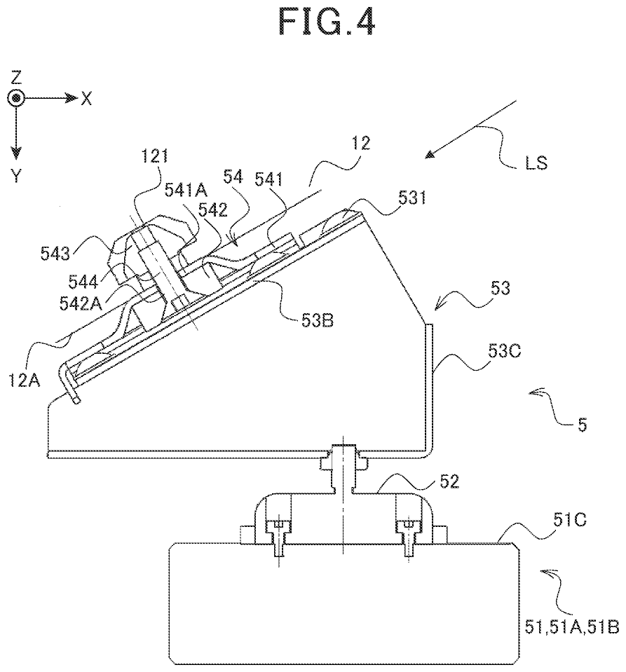

The voice operation device 51 is fixed to the machine column 12 by the fixing mechanism 5. The fixing mechanism 5 will be further described with reference to FIGS. 4 to 6.

As illustrated in FIG. 3, a surface 12A of the machine column 12 where the groove 121 is formed is inclined from a lower left side to an upper right side. That is, the surface 12A is inclined rearward from left to right. In other words, the surface 12A is inclined from the front left to the rear right.

This point will be further described with reference to FIG. 4.

Next, referring back to FIG. 1, the configuration of the tensile testing machine main body 2 will be described.

The tensile testing machine main body 2 includes the table 26, a pair of screw rods 28 and 29, the crosshead 10, a load mechanism 15, and a load cell 14.

The pair of screw rods 28 and 29 is rotatably erected on the table 26 in a state of facing the vertical direction. The crosshead 10 is configured to be movable along the screw rods 28 and 29. The load mechanism 15 moves the crosshead 10 to apply a load to the test piece TP.

The load cell 14 is a sensor that measures the test force F, which is a tensile load applied to the test piece TP, and outputs a test force measurement signal SG1.

The load mechanism 15 includes a worm speed reducer 16, a worm speed reducer 17, a servomotor 18, and a rotary encoder 20.

The worm speed reducer 16 and the worm speed reducer 17 are connected to lower end portions of the pair of the screw rods 28 and 29, respectively. The servomotor 18 is connected to each of the worm speed reducer 16 and the worm speed reducer 17.

The rotary encoder 20 is a sensor that measures a rotation amount of the servomotor 18 and outputs, to the control device 3, a rotation measurement signal SG2 of the number of pulses corresponding to the rotation amount.

The load mechanism 15 transmits a rotation of the servomotor 18 to the pair of screw rods 28 and 29 via the worm speed reducers 16 and 17, respectively. The pair of screw rods 28 and 29 rotate in synchronization with each other, so that the crosshead 10 moves up and down along the pair of screw rods 28 and 29.

The upper gripper 21 for gripping the upper end portion of the test piece TP is attached to the crosshead 10, and the lower gripper 22 for gripping the lower end portion of the test piece TP is attached to the table 26. When a tensile test is performed, the tensile testing machine main body 2 raises the crosshead 10 under control of the control device 3 with both ends of the test piece TP gripped by the upper gripper 21 and the lower gripper 22, thereby applying the test force F to the test piece TP.

### [1-2. Configuration of Control Device]

Next, a configuration of the control device 3 will be described with reference to FIG. 1.

The control device 3 includes: a processor 31 such as a central processing unit (CPU) or a micro-processing unit (MPU); a memory device 32 such as a read only memory (ROM) or a random access memory (RAM); and an interface circuit for connecting various peripheral devices. The memory device 32 may include a storage device such as a hard disk drive (HDD) or a solid state drive (SSD).

The memory device 32 stores a control program 321.

The test force measurement signal SG1, the rotation measurement signal SG2, and the text information TX are input to the control device 3. The test force measurement signal SG1 is a signal indicating the magnitude of the test force F output from the load cell 14. The rotation measurement signal SG2 is a signal indicating the rotation amount output from the rotary encoder 20. The text information TX is text information output from the voice operation device 51 and is text information corresponding to a voice of an operator.

The processor 31 functions as a testing machine control unit 311 and a test execution unit 312 by executing the control program 321.

The testing machine control unit 311 controls an operation of the tensile testing machine main body 2 based on an operation signal CM from the operation unit 4 and the text information TX from the voice operation device 51. When receiving the operation signal CM from the operation unit 4, the testing machine control unit 311 causes the tensile testing machine main body 2 to execute an operation corresponding to the operation signal CM. When receiving the text information TX from the voice operation device 51, the testing machine control unit 311 causes the tensile testing machine main body 2 to execute an operation corresponding to the text information TX.

The test execution unit 312 performs a tensile test by feedback-controlling the servomotor 18 of the tensile testing machine main body 2. For example, the test execution unit 312 executes a position control on a test force measurement value output from the load cell 14. In this case, the test execution unit 312 calculates a command value of a displacement measurement value such that the test force measurement value matches a test force target value, and outputs a command signal indicating the command value to the servomotor 18 via a servo amplifier (not illustrated). Note that the displacement measurement value indicates a displacement of the crosshead 10 based on the rotation measurement signal SG2. The test force target value indicates a target value of the test force measurement value corresponding to the test force measurement signal SG1.

### 2. Configuration of Fixing Mechanism of Voice Operation Device

Next, a configuration of the fixing mechanism 5 of the voice operation device 51 will be described with reference to FIGS. 4 to 6.

FIG. 4 is a plan view illustrating an example of the configuration of the fixing mechanism 5 of the voice operation device 51.

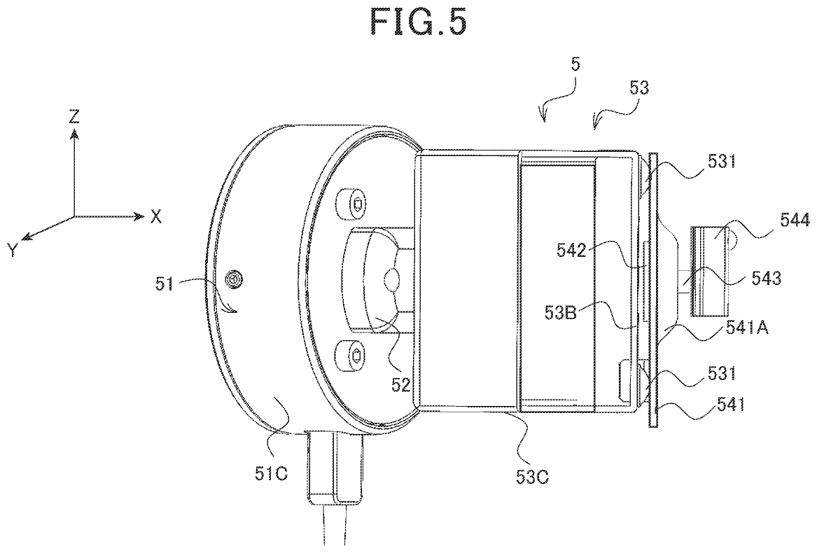

FIG. 5 is a perspective view illustrating an example of the configuration of the fixing mechanism 5 of the voice operation device 51. FIG. 5 is a side view of the fixing mechanism 5 as viewed in a line of sight LS illustrated in FIG. 4.

As illustrated in FIG. 4, the line of sight LS is a direction orthogonal to the Z axis and parallel to the surface 12A of the machine column 12 in which the groove 121 is formed.

The fixing mechanism 5 fixes the voice operation device 51 to the machine column 12.

As illustrated in FIGS. 4 and 5, the fixing mechanism 5 includes a joint 52, a stand 53, three or more elastic bodies 531, and a fixing member 54.

The joint 52 is fixed to a front surface of the stand 53 and rotatably couples the voice operation device 51.

The stand 53 supports the voice operation device 51 via the joint 52. The stand 53 includes a housing 53C. The housing 53C is formed in a substantially trapezoidal shape in plan view as illustrated in FIG. 4 and in a rectangular shape in side view as illustrated in FIG. 5. The housing 53C is made of a magnetic material such as iron or stainless steel. The housing 53C fixes one end of the joint 52. The other end of the joint 52 is fixed to the voice operation device 51.

In this manner, the voice operation device 51, the joint 52, and the stand 53 are integrally configured.

Each of the three or more elastic bodies 531 is fixed to a surface of the housing 53C on a side close to the machine column 12, that is, a back surface 53B. Each of the three or more elastic bodies 531 is fixed to the back surface 53B of the housing 53C with, for example, an adhesive. The elastic body 531 is made of, for example, a resin such as rubber. The elastic body 531 is, for example, natural rubber, polyurethane, or the like.

The back surface 53B of the housing 53C of the stand 53 corresponds to an example of “side of the voice operation device side”.

In addition, each of the three or more elastic bodies 531 is formed in a spherical shape. That is, each of the three or more elastic bodies 531 is formed in a shape in which a part of a sphere is cut out in a plane. The surface of each of the three or more elastic bodies 531 includes a planar surface and a spherical surface. The planar surface of each of the three or more elastic bodies 531 is fixed to the housing 53C with an adhesive.

Each of the three or more elastic bodies 531 is disposed such that the spherical surface thereof is substantially in point contact with a peripheral portion of a mounting plate 541 of the fixing member 54.

The mounting plate 541 corresponds to an example of “side of the machine column”.

The fixing member 54 includes the mounting plate 541, a magnet body 542, a T-slot nut 543, and a bolt 544.

The T-slot nut 543 is fitted into the groove 121 formed in the machine column 12. The bolt 544 is inserted into a hole formed in each of the magnet body 542 and the mounting plate 541, and is screwed with the T-slot nut 543, thereby fixing each of the magnet body 542 and the mounting plate 541 to the machine column 12.

The magnet body 542 is, for example, a permanent magnet, and is fixed to the machine column 12 by the bolt 544 and the T-slot nut 543. The magnet body 542 detachably fixes the stand 53 by attracting the housing 53C of the stand 53 by a magnetic force. Since the stand 53 supports the voice operation device 51 via the joint 52, the voice operation device 51 is fixed to the machine column 12 by the stand 53 being sucked and fixed by the magnet body 542.

That is, the voice operation device 51, the joint 52, the stand 53, and the three or more elastic bodies 531 are integrally configured to be detachable from the machine column 12. In other words, the voice operation device 51, the joint 52, the stand 53, and the three or more elastic bodies 531 are integrally configured to be detachable from the machine column 12.

The mounting plate 541 forms a recess 541A that houses the magnet body 542, and the magnet body 542 is housed. The mounting plate 541 is fixed between the magnet body 542 and the machine column 12 by the bolt 544 and the T-slot nut 543. The recess 541A formed by the mounting plate 541 is in contact with the surface 12A of the machine column 12 in which the groove 121 is formed.

The recess 541A of the mounting plate 541 corresponds to an example of “side of the machine column”.

The spherical surface of each of the three or more elastic bodies 531 is substantially in point contact with the peripheral portion of mounting plate 541. That is, the magnet body 542 attracts the housing 53C of the stand 53 by the magnetic force, and the mounting plate 541 pushes back the spherical surface of each of the three or more elastic bodies 531 by a reaction force, whereby the stand 53 is fixed in a state of being separated from the mounting plate 541.

The stand 53 corresponds to an example of “side of the voice operation device side”.

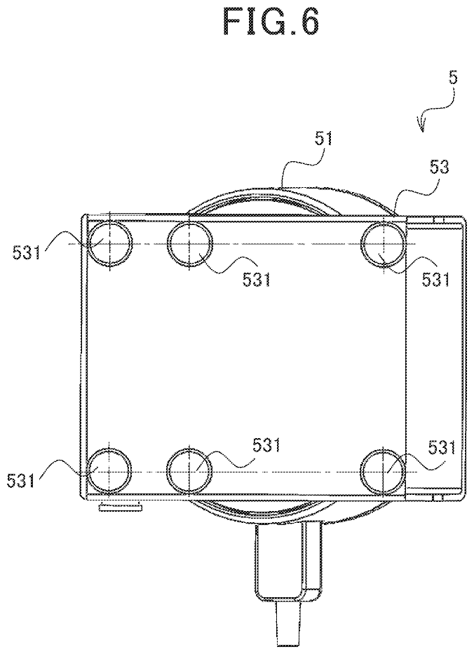

FIG. 6 is a rear view of the stand 53 illustrating an arrangement of the elastic bodies 531. In other words, FIG. 6 is a view in which the stand 53 integrally configured with the voice operation device 51 and the joint 52 is detached from the fixing mechanism 5 and viewed from the back surface 53B of the stand 53, that is, a surface on a side to which the three or more elastic bodies 531 are attached.

As illustrated in FIG. 6, six elastic bodies 531 are attached to the back surface 53B of the stand 53. The six elastic bodies 531 are an example of the three or more elastic bodies 531. That is, in the present embodiment, “three or more” is six.

For example, the back surface 53B of the stand 53 is formed in a rectangular shape, and the six elastic bodies 531 are disposed in two rows along the long side direction (left-right direction in FIG. 6) of the stand 53. Furthermore, the six elastic bodies 531 are disposed in three rows along the short-side direction (upper-lower direction in FIG. 6) of the stand 53.

In the long-side direction (left-right direction in FIG. 6) of the stand 53, two elastic bodies 531 disposed at positions other than both ends are disposed on the left side of the center of the stand 53 in the long-side direction.

By disposing the six elastic bodies 531 on the back surface 53B of the stand 53 in this manner, it is possible to stably dispose the stand 53 integrally configured with the voice operation device 51 and the joint 52 in both a case where the stand 53 is sucked and fixed to the machine column 12 by the magnetic force via the mounting plate 541 and a case where the stand 53 is disposed on a desk or the like.

Moreover, when the stand 53 integrally configured with the voice operation device 51 and the joint 52 is disposed on a desk or the like, an operator can adjust the voice operation device 51 to a desired direction by rotating the voice operation device 51 with respect to the joint 52.

In addition, as illustrated in FIG. 4, in a case where the stand 53 integrally configured with the voice operation device 51 and the joint 52 is fixed to the machine column 12, the stand 53 is formed in a substantially trapezoidal shape in plan view, so that the voice operation device 51 can be disposed in a positive direction of the Y axis, that is, in a forward direction.

Moreover, in this case, an operator can adjust the voice operation device 51 to a desired direction by rotating the voice operation device 51 with respect to the joint 52.

As described with reference to FIGS. 1 to 6, the fixing mechanism 5 includes the three or more elastic bodies 531 and the magnet body 542. The three or more elastic bodies 531 are attached to the back surface 53B of the stand 53, which is an example of “side of the voice operation device”, and are disposed substantially in point contact with the mounting plate 541, which is an example of “side of the machine column”. The magnet body 542 is attached to the recess 541A of the mounting plate 541, which is an example of “side of the machine column”, and is disposed in non-contact with the stand 53, which is an example of “side of the voice operation device side”, to suck and fix the stand 53, which is an example of “side of the voice operation device”.

As described above, the magnet body 542 is attached to the machine column 12 and is disposed in non-contact with the stand 53 integrally configured with the voice operation device 51, thereby sucking and fixing the stand 53 to the machine column 12. Therefore, vibration transmitted from the machine column 12 to the voice operation device 51 can be transmitted only via the three or more elastic bodies 531.

Since the three or more elastic bodies 531 are attached to the back surface 53B of the housing 53C of the stand 53 and are disposed substantially in point contact with the mounting plate 541, the vibration of the machine column 12 is transmitted to the stand 53 only via the three or more elastic bodies 531. Furthermore, since the voice operation device 51, the joint 52, and the stand 53 are integrally configured, the vibration of the machine column 12 is transmitted from the stand 53 to the voice operation device 51.

Therefore, since the vibration of the machine column 12 is transmitted to the stand 53 only via the three or more elastic bodies 531, the vibration is absorbed by the three or more elastic bodies 531, and the vibration transmitted to the stand 53 can be suppressed. In addition, since the three or more elastic bodies 531 are disposed substantially in point contact with the mounting plate 541, the vibration transmitted from the machine column 12 to the stand 53 can be suppressed. Therefore, the vibration transmitted from the machine column 12 to the voice operation device 51 can be suppressed.

In addition, the mounting plate 541 is disposed, on the machine column 12, integrally with the magnet body 542, and the three or more elastic bodies 531 are substantially in point contact with the peripheral portion of mounting plate 541.

Therefore, by attaching the magnet body 542 to the recess 541A of the mounting plate 541, the magnet body 542 can be disposed in non-contact with the stand 53, and the three or more elastic bodies 531 can be disposed substantially in point contact with the peripheral portion of the mounting plate 541. Therefore, the vibration transmitted from the machine column 12 to the voice operation device 51 can be suppressed.

In addition, the three or more elastic bodies 531 are attached to the voice operation device 51 via the joint 52 and the stand 53, the voice operation device 51 is detachable integrally with the three or more elastic bodies 531, and the three or more elastic bodies 531 function as anti-slip members when the voice operation device 51 is detached and placed on a desk.

Thus, when the voice operation device 51 is detached and placed on a desk, the three or more elastic bodies 531 function as anti-slip members, so that the voice operation device 51 can be stably disposed on the desk. Therefore, the convenience of the operator can be improved.

Furthermore, the three or more elastic bodies 531 has a spherical shape.

Therefore, the three or more elastic bodies 531 can be easily formed.

### 3. Aspects and Effects

It is understood by those skilled in the art that the above-described embodiments are specific examples of the following aspects.

### (Clause 1)

A material testing machine (1) according to one aspect is a material testing machine including a voice operation device (51), in which the voice operation device is attached to a machine column (12) via a fixing mechanism (5), and the fixing mechanism includes: three or more elastic bodies (531) attached to either one side of the machine column and the voice operation device and disposed substantially in point contact with another side; and a magnet body (542) attached to the other side and disposed in non-contact with the one side to suck and fix the one side.

With the material testing machine according to clause 1, the magnet body is disposed in non-contact with a side of the machine column or a side of the voice operation device, and the side of the voice operation device is sucked and fixed to the side of the machine column. Therefore, vibration transmitted from the side of the machine column to the side of the voice operation device can be transmitted only via the three or more elastic bodies.

Furthermore, since the vibration on the side of the machine column is transmitted to the side of the voice operation device only via the three or more elastic bodies, the vibration is absorbed by the three or more elastic bodies, and the vibration transmitted to the side of the voice operation device can be suppressed. In addition, since the three or more elastic bodies are disposed substantially in point contact with the side of the machine column or the side of the voice operation device, it is possible to suppress vibration transmitted from the side of the machine column to the side of the voice operation device. Therefore, vibration transmitted from the side of the machine column to the side of the voice operation device can be suppressed.

### (Clause 2)

In the material testing machine according to clause 1, a mounting plate (541) is disposed, on the machine column, integrally with the magnet body, and the three or more elastic bodies are substantially in point contact with a peripheral portion of the mounting plate.

With the material testing machine described in clause 2, since the magnet body and the mounting plate are integrally fixed to the machine column, the three or more elastic bodies can be easily disposed so as to be substantially in point contact with the peripheral portion of the mounting plate. Therefore, vibration transmitted from the side of the machine column to the side of the voice operation device can be suppressed.

### (Clause 3)

In the material testing machine according to clause 1, the three or more elastic bodies are attached to the voice operation device, the voice operation device is detachable integrally with the three or more elastic bodies, and the three or more elastic bodies function as anti-slip members when the voice operation device is detached and placed on a desk.

With the material testing machine described in clause 3, when the voice operation device is detached and placed on a desk, the three or more elastic bodies function as anti-slip members, so that the voice operation device can be stably disposed on the desk. Therefore, the convenience of the operator can be improved.

### (Clause 4)

In the material testing machine according to any one of clauses 1 to 3, each of the three or more elastic bodies has a spherical shape.

With the material testing machine described in clause 4, each of the three or more elastic body can be easily formed into a shape substantially in point contact with a side of the machine column or a side of the voice operation device.

### (Clause 5)

A fixing mechanism (5) according to one aspect is a fixing mechanism for fixing a voice operation device (51) to a machine column (12) of a material testing machine (1), the fixing machine including: three or more elastic bodies (531) attached to either one side of the machine column and the voice operation device and disposed substantially in point contact with another side; and a magnet body (542) attached to the other side and disposed in non-contact with the one side to suck and fix the one side.

With the fixing mechanism described in clause 5, the same effect as that of the material testing machine described in clause 1 is obtained.

### 4. Other Embodiments

In the embodiment of the present invention, a case where the “material testing machine” is the tensile testing machine 1 is described, but the embodiment of the present invention is not limited thereto. The “material testing machine” may be a compression testing machine.

Furthermore, the material testing machine may be a bending testing machine, an impact testing machine, or a fatigue testing machine.

In addition, in the embodiment of the present invention, a case where the “either one side of the machine column and the voice operation device” is a side of the voice operation device 51 and “the other side” is a side of the machine column 12 is described, but the embodiment of the present invention is not limited thereto. The “either one side of the machine column and the voice operation device” may be the side of the machine column 12, and “the other side” may be the side of the voice operation device 51.

In this case, since the magnet body 542 is disposed on the side of the voice operation device 51, the microphone 51A and the voice recognition board 51B disposed in the voice operation device 51 are preferably shielded so as not to be affected by a magnetic field from the magnet body 542.

In other words, in the embodiment of the present invention, since the magnet body 542 is disposed on the side of the machine column 12, the microphone 51A and the voice recognition board 51B disposed in the voice operation device 51 are hardly affected by the magnetic field from the magnet body 542. Therefore, it is not necessary to shield the microphone 51A and the voice recognition board 51B disposed in the voice operation device 51 so as not to be affected by a magnetic field from the magnet body 542.

Furthermore, in the embodiment of the present invention, since the magnet body 542 is disposed on the side of the machine column 12, the weight of the voice operation device 51, the joint 52, and the stand 53 which are integrally configured can be reduced as compared with a case where the magnet body 542 is disposed on the side of the voice operation device 51. Therefore, the convenience of the operator can be improved.

In addition, in the embodiment of the present invention, a case where each of three or more elastic bodies 531 has a spherical shape is described, but the embodiment of the present invention is not limited thereto. Each of the three or more elastic bodies 531 may have, for example, a conical shape. Moreover, each of the three or more elastic bodies 531 may have, for example, a pyramid shape.

In addition, in the embodiment of the present invention, a case where the number of the elastic bodies 531 is six is described, but the embodiment of the present invention is not limited thereto. The number of the elastic bodies 531 may be three or more. For example, the number of the elastic bodies 531 may be three, four, or five. Moreover, for example, the number of the elastic bodies 531 may be seven or more. As the number of the elastic bodies 531 decreases, the configuration of the fixing mechanism 5 can be simplified. In addition, as the number of the elastic bodies 531 increases, a force received by one elastic body 531 decreases, so that deformation of the elastic body 531 can be reduced. Therefore, the life of the elastic body 531 can be extended.

In the embodiment of the present invention, a case where the three or more elastic bodies 531 are natural rubber, polyurethane, or the like are described, but the embodiment of the present invention is not limited thereto. It is sufficient that the three or more elastic bodies 531 have elasticity.

Furthermore, in the embodiment of the present invention, a case where the voice operation device 51 is integrally configured with the joint 52 and the stand 53 is described, but the embodiment of the present invention is not limited thereto. For example, the three or more elastic bodies 531 may be fixed to the voice operation device 51, and the housing of the voice operation device 51 may be sucked and fixed by the magnet body 542.

Furthermore, in the embodiment of the present invention, a case where the voice operation device 51 includes the microphone 51A and the voice recognition board 51B has been described, but the embodiment of the present invention is not limited thereto. It is sufficient that the voice operation device 51 includes the microphone 51A. In other words, the voice operation device 51 does not need to include the voice recognition board 51B. In this case, the control device 3 needs to include a voice recognition board.

Note that the tensile testing machine 1 according to the embodiment of the present invention is merely an example of an aspect of a “material testing machine” according to the present invention, and can be modified and applied as desired without departing from the gist of the present invention. In addition, the fixing mechanism 5 according to the embodiment of the present invention is merely an example of an aspect of the “fixing mechanism” according to the present invention, and can be modified and applied as desired without departing from the gist of the present invention.

### DESCRIPTION OF REFERENCE NUMERALS

1 Tensile testing machine (material testing machine)
2 Tensile testing machine main body
10 Crosshead
11, 12 Machine column
121 Groove
21 Upper gripper
22 Lower gripper
51 Voice operation device
51A Microphone
51B Voice recognition board
5 Fixing mechanism
52 Joint
53 Stand
531 Elastic body
53B Back surface
53C Housing
54 Fixing member
541 Mounting plate
541A Recess
542 Magnet body
543 T-slot nut
544 Bolt

What is claimed is:

1. A material testing machine comprising a voice operation device, wherein
the voice operation device is attached to a machine column via a fixing mechanism, and
the fixing mechanism includes:
three or more elastic bodies attached to either one side of the machine column and the voice operation device and disposed in contact with another side; and
a magnet body attached to the other side and disposed in non-contact with the one side to suck and fix the one side.

2. The material testing machine according to claim 1, wherein
the three or more elastic bodies attached to either one side of the machine column and the voice operation device and disposed substantially in point contact with another side.

3. The material testing machine according to claim 1, wherein
a mounting plate is disposed, on the machine column, integrally with the magnet body, and
the three or more elastic bodies are substantially in point contact with a peripheral portion of the mounting plate.

4. The material testing machine according to claim 1, wherein
the three or more elastic bodies are attached to the voice operation device,
the voice operation device is detachable integrally with the three or more elastic bodies, and
the three or more elastic bodies function as anti-slip members when the voice operation device is detached and placed on a desk.

5. The material testing machine according to claim 1, wherein each of the three or more elastic bodies has a spherical shape.

6. A fixing mechanism for fixing a voice operation device to a machine column of a material testing machine, the fixing mechanism comprising:
three or more elastic bodies attached to either one side of the machine column and the voice operation device and disposed in contact with another side; and
a magnet body attached to the other side and disposed in non-contact with the one side to suck and fix the one side.
